(19) United States
(12) Patent Application Publication
(10) Pub. No.: US 2015/0122196 A1
(43) Pub. Date: May 7, 2015

(54) UNFOLDABLE PORTABLE PET BAG

(71) Applicants: Chung-Yuan Liu, Minxiong Township (TW); Tai-Shen Huang, Taichung City (TW)

(72) Inventors: Chung-Yuan Liu, Minxiong Township (TW); Tai-Shen Huang, Taichung City (TW)

(73) Assignee: PETRICK ENTERPRISE CO., LTD., Hemei Township (TW)

(21) Appl. No.: 14/071,023

(22) Filed: Nov. 4, 2013

(51) Int. Cl. A01K 1/02; A01K 1/035

(52) U.S. Cl. CPC A01K 1/0254; A01K 1/0353
USPC 119/497

(57) ABSTRACT

An unfoldable portable pet bag has a bearing plate portion, extensible peripheral portion, lacing holes, control pull-cord, flexible portions and pulling and lifting portions. The portable pet bags can be unfolded and directly used as a mat for pets. Moreover, the unfoldable portable pet bag is flat when it is unfolded, enabling elimination of blind corners and making it easier for cleaning and drying. When pet owners plan to take pets with them, the pets could step into (or be carried into) the bearing plate portion. Next, the extensible peripheral portion can be quickly converged into a vertical framed body via upward pulling of said pulling and lifting portion. This could completely solve the problem of pets getting stuck when they're put into or taken out of the pet container, making it more convenient, quicker and safer to carry the pets with multiple functions.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a pet bag, and more particularly to an innovative one which is designed into a portable bag with unfoldable pattern and function.

2. Description of Related Art Including Information Disclosed Under 37 CFR 1.97 and 37 CFR 1.98.

With the increasing living standard and higher demand of the general public in modern era, more focus is now put on the development of related pet products.

Containers for pets always occupy a quite large market portion since many pet owners with preference for small-sized pets (e.g. small-sized dogs and cats) often opt to carry these pets with them, however; once the environment is not suitable for pets to walk around, the owners have no option but to put them into some portable pet containers.

Said portable pet containers structurally include cages, boxes and bags, etc. Such a structure is basically prefabricated into specific patterns of cages, boxes and bags, with an opening left on the top for the owners to put their pets or take them out. However, some shortcomings are still observed during actual applications. For example, no matter the portable pet containers are prefabricated into patterns of cages, boxes or bags, the top is usually designed into a tapered shape, minimize the volume of containers for easier carrying. As a result, the top opening is often too small, and it will get stuck when the owners put their pets or take them out. For instance, the feet of pets may be blocked at the opening or the owner's hand is not easy to stretch into the container. Moreover, if the pets are hurt or found sick after they're stuck, they're likely reluctant to access the pet container in the future, increasing the problem of the owners.

On the other hand, due to 3D patterns of said portable pet container structure, when residual pet waste must be cleaned, the problems and disadvantages such as inconvenient cleaning and difficult drying for many blind corners will occur.

Furthermore, given that the pets are accustomed to the environment with familiar a smell, when the owners carry the pets with them, another special mat will be prepared for the pets. As a result, the owners should carry a pet container and a mat inconveniently.

Thus, to overcome the aforementioned problems of the prior art, it would be an advancement if the art to provide an improved structure that can significantly improve the efficacy.

Therefore, the inventor has provided the present invention of practicability after deliberate design and evaluation based on year of experience in the production, development and design of related products.

### BRIEF SUMMARY OF THE INVENTION

Based on the unique design of the present invention wherein the “unfoldable portable pet bag” mainly comprises: a bearing plate portion, extensible peripheral portion, lacing holes, control pull-cord, flexible portions and pulling and lifting portions, the present invention, could provide a brand new unfoldable, portable pet bag structure, which can be unfolded and directly used as a mat for pets, thus the owners could mitigate the burden without need of taking a mat. Moreover, the unfoldable portable pet bag of the present invention is flat when it is unfolded, enabling elimination of blind corners and making it easier for cleaning and drying, etc. When the owners plan to take pets with them, the pets could step into (or be carried into) the bearing plate portion. Next, said extensible peripheral portion can be quickly converged into a vertical framed body via upward pulling of said pulling and lifting portion. This could completely solve the problem wherein the pets are likely stuck when they're put into or taken out of the pet container, making it more convenient, quicker and safer to carry the pets with multiple functions.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is a perspective view of the preferred embodiment of the present invention.

FIG. 2 is a perspective view of the extensible peripheral portion of the present invention that is horizontally unfolded (note: the control pull-cord is in a decomposed state).

FIG. 3 is a service status view 1 of the present invention.

FIG. 4 is a service status view 2 of the present invention.

FIG. 5 is a service status view 3 of the present invention.

FIG. 6 shows a preferred embodiment of the present invention wherein the pulling and lifting portion is designed into a belt pattern.

FIG. 7 shows a preferred embodiment of the present invention wherein the pulling and lifting portion is designed into a strap pattern.

### DETAILED DESCRIPTION OF THE INVENTION

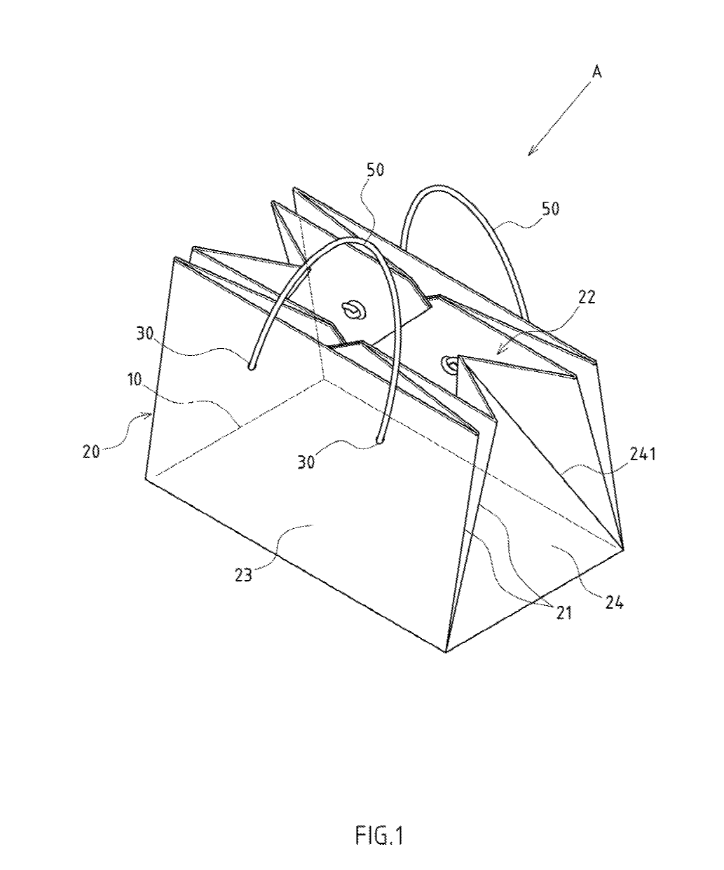

FIGS. 1, 2, 3 and 4 depict preferred embodiments of the unfoldable portable pet bag of the present invention, which, however, are provided for only explanatory objective for patent claims.

Said portable pet bag A is composed of a bearing plate portion 10, made of a plate-like body with pet bearing strength (note: or made of plastic plate, wood board, cardboard or other composite fabric materials). The bearing plate portion 10 is horizontally arranged in a state of readiness.

An extensible peripheral portion 20 is connected to the periphery of bearing plate portion 10 in a circumferentially surrounded pattern. Said extensible peripheral portion 20 can be horizontally unfolded or vertically folded in relation to the bearing plate portion 10. It is provided with several flexible portions 21, which enable folding of the extensible peripheral portion 20 into a vertical framed pattern (shown in FIG. 1), and formation of a box body and pet holding space 22 in conjunction with the bearing plate portion 10 (shown in FIG. 1).

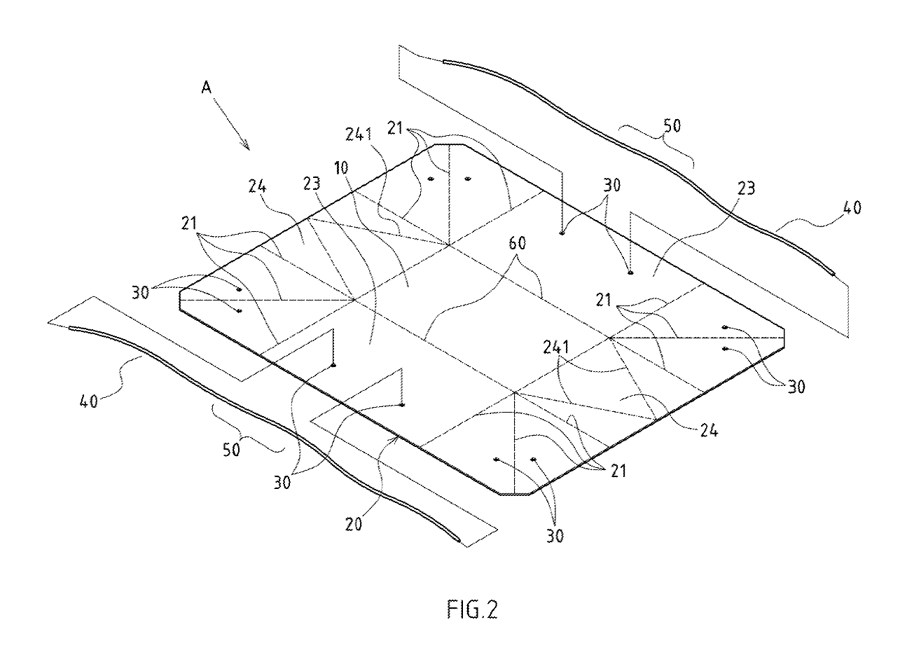

Several lacing holes 30 are arranged at interval and located in the opposite area of the extensible peripheral portion 20 (shown in FIG. 2). Each lacing hole 30 is arranged along the circumferential extending direction of extensible peripheral portion 20.

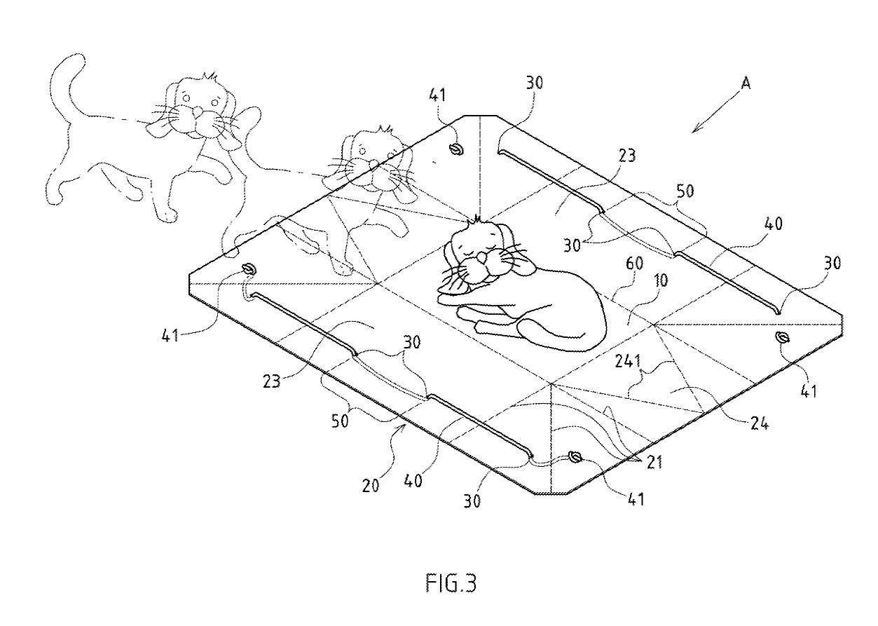

At least one control pull-cord 40 penetrates through the lacing holes 30 set in the opposite area of the extensible peripheral portion 20, and crosses the flexible portion 21 in a staggered state. Said control pull-cord 40 is provided with at least two locating ends 41 (marked in FIG. 3) fixed at two opposite sides of the extensible peripheral portion 20.

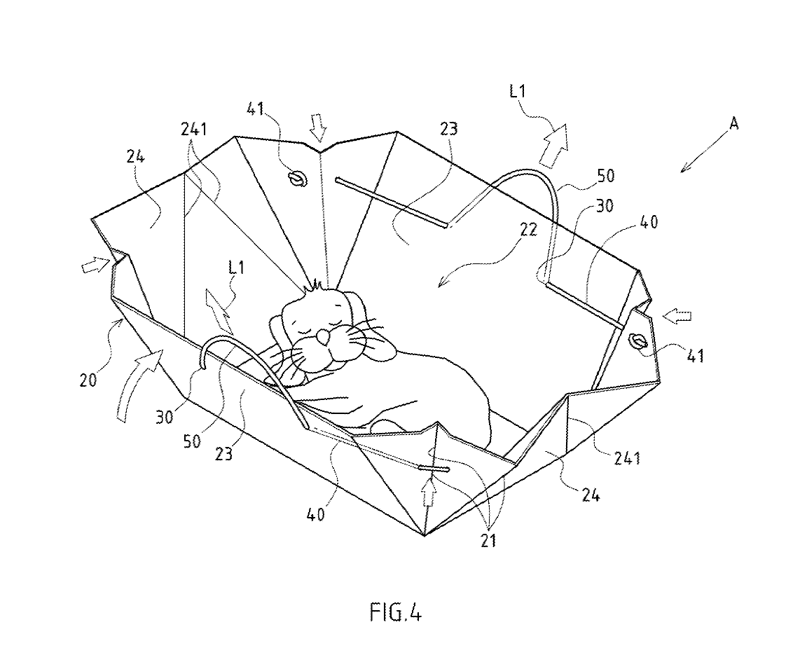

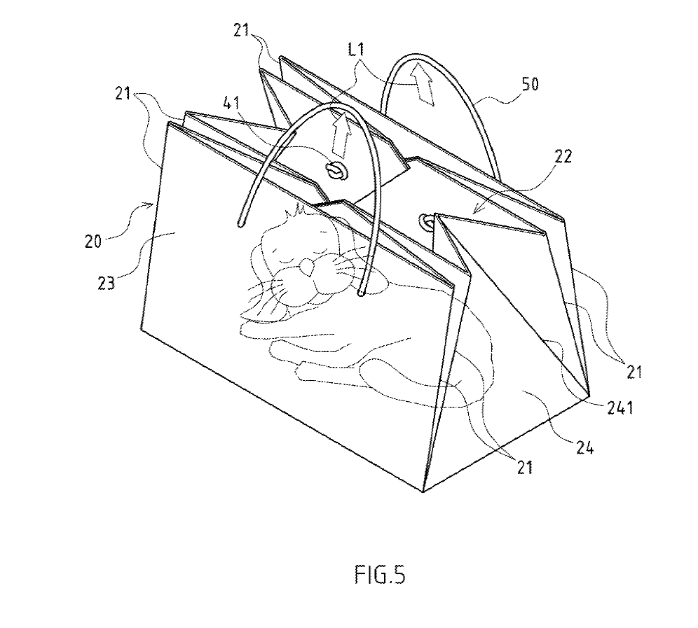

Two pulling and lifting portions 50 are composed of sections located between two lacing holes 30 at opposite sides of the control pull-cord 40. When the extensible peripheral portion 20 is vertically folded, it can be lifted upward by these two pulling and lifting portions 50 (shown by arrow L1 in FIGS. 4 and 5), so that the extensible peripheral portion 20 could be converged to form a vertical framed body, meanwhile, these two pulling and lifting portions 50 could be used for manual lifting.

Referring to FIGS. 2 and 3, the bearing plate portion 10 is of a rectangular planar pattern, and the extensible peripheral portion 20 is of a plate-like pattern; said extensible peripheral portion 20 is connected to the bearing, plate portion 10 via a flexible connecting flange 60. The flexible portions 21 are of a V-shaped pre-folded pattern set in four corner areas of the extensible peripheral portion 20. So, the extensible peripheral portion 20 could be divided into two lateral plate portions 23 and two end plate portions 24 spaced oppositely with different dimensions. The lateral plate portion 23 and end plate portion 24 can be converged into a rectangular, vertical framed body via the flexible changes of the Y-shaped flexible portions 21. Two control pull-cords 40 separately penetrate two lateral plate portions 22 as well as the lacing holes 30 respectively passing through two adjacent two corner areas, but these two end plate portions 23 are not fitted with lacing holes. Two locating ends 41 of each control pull-cord 40 are separately fixed in two corner areas, and said pulling and lifting portions 50 are formed at the section between two lacing boles 30 of said lateral plate portion 23.

Referring to FIGS. 2 and 3, these two end plate portions 24 could form inverted V-shaped pre-folded lines 241 so that When the extensible peripheral portion is vertically folded, the top end of these two end plate portions 24 can be folded in a reducing state (shown in FIG. 5).

Of which, said extensible peripheral portion 20 is made of flexible planar materials (such as woven cloth, canvas and soft rubber sheets). Further, said flexible portions 21 are of a rugged pattern formed by the flexibility of said extensible peripheral portion 20 (note: figures therein are omitted).

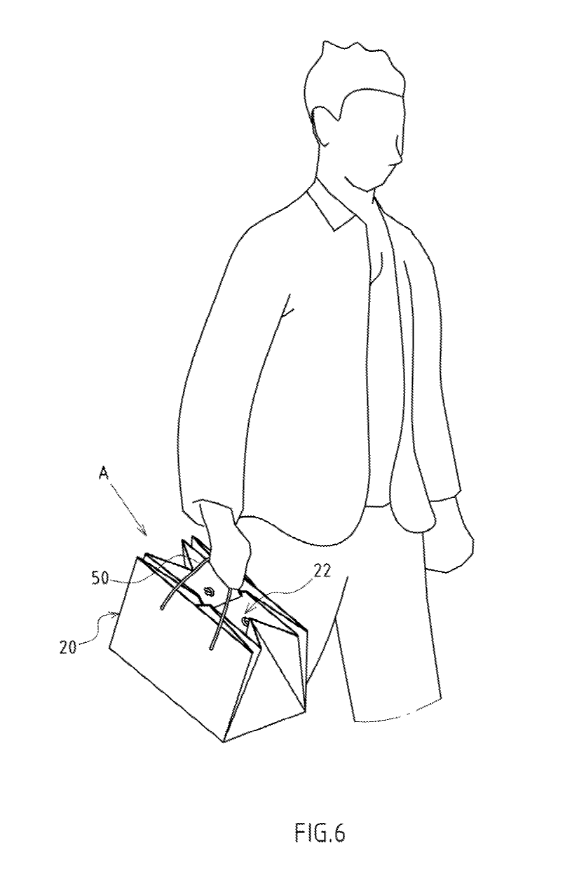

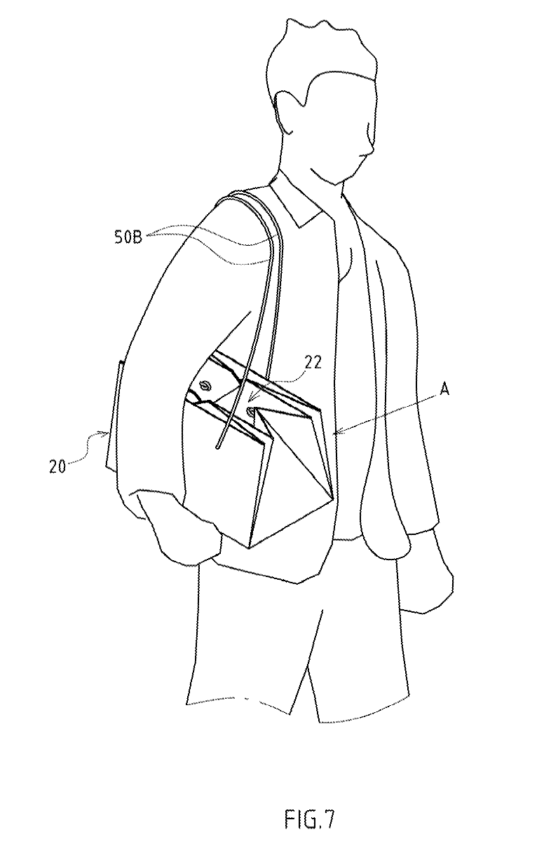

Of which, said pulling and lifting portion 50 is of a belt/strap pattern. The pulling and lifting portion 50 shown in FIG. 6 is a preferred embodiment of a belt pattern. The pulling and lifting portion 50B shown in FIG. 7 is a preferred embodiment of strap pattern.

Based on the above-mentioned structural design, the unfolded portable pet bag of the present invention could be utilized in such a manner that the extensible peripheral portion 20 can be horizontally unfolded (shown in FIG. 3) or vertically folded (shown in FIG. 1) in relation to the bearing plate portion 10. With these flexible functions and features, when the extensible peripheral portion 20 is horizontally unfolded, it can be used as a mat for the pets. When the owners plan to take pets with them, the pets could step into (or be carried into) the bearing plate portion 10 (shown in FIG. 3). Next, said extensible peripheral portion 20 can be quickly converged, into a vertical framed body via upward pulling of said pulling and lifting portion 50 (shown by arrow L1 in FIGS. 4 and 5) to accommodate the pets. Referring to FIG. 6, the owners can hold and carry the portable pet bag A with pets inside via upward pulling of said pulling and lifting portion 50.

1. An unfoldable portable pet bag comprising:
a bearing plate portion, made of a plate-like body with pet bearing strength; and the bearing plate portion 10 is horizontally arranged in a state of readiness;
an extensible peripheral portion, connected to the periphery of bearing plate portion in a circumferentially surrounded pattern; said extensible peripheral portion can be horizontally unfolded or vertically folded in relation to the bearing plate portion; and it is provided with several flexible portions, which enable folding of the extensible peripheral portion into a vertical framed pattern, and formation of a box body and pet holding space in conjunction with the bearing plate portion;
several lacing holes, arranged at interval and located in the opposite area of the extensible peripheral portion; and each lacing hole is arranged along the circumferential extending direction of extensible peripheral portion;
at least one control pull-cord, penetrating through the lacing holes set in the opposite area of the extensible peripheral portion, and crossing, the flexible portion in a staggered state; said control pull-cord is provided with at least two locating ends fixed at two opposite sides of the extensible peripheral portion;
two pulling and lifting portions, composed of sections located between two lacing holes at opposite sides of the control pull-cord; when the extensible peripheral portion is vertically folded, it can be lifted upward by these two pulling and lifting portions, so that the extensible peripheral portion could be converged to form a vertical framed body, meanwhile, these two pulling and lifting portions could be used for manual lifting.

2. The structure defined in claim 1, wherein the bearing plate is of a rectangular planar pattern, and the extensible peripheral portion is of a plate-like pattern; said extensible peripheral portion is connected to the bearing plate portion via a flexible connecting flange; the flexible portions are of a Y-shaped pre-folded pattern set in four corner areas of the extensible peripheral portion; so the extensible peripheral portion could be divided into two lateral plate portions and two end plate portions spaced oppositely with different dimensions; the lateral plate portion and end plate portion can be converged into a rectangular, vertical framed body via the flexible changes of the Y-shaped flexible portions; two control pull-cords separately penetrate two lateral plate portions as well as the lacing holes respectively passing through two adjacent two corner areas, but these two end plate portions are not fitted with lacing holes; two locating ends of each control pull-cord are separately fixed in two corner areas, and said pulling and lifting portions are formed at the section between two lacing holes of said lateral plate portion.

3. The structure defined in claim 2, wherein these two end plate portions form inverted V-shaped pre-folded lines, so that when the extensible peripheral portion is vertically folded, the top end of these two end plate portions can be folded in a reducing state.

4. The structure defined in claim 1, wherein said extensible peripheral portion is made of flexible planar materials; and said flexible portions are of a rugged pattern formed by the flexibility of said extensible peripheral portion.

5. The structure defined in claim 2, wherein said pulling and lifting portion is of a belt/strap pattern.
